(19) United States
(12) Patent Application Publication
(10) Pub. No.: US 2019/0031484 A1
(43) Pub. Date: Jan. 31, 2019

(54) Beer tap improvement system for colored beer and other additives

(71) Applicant: Timothy J. Allgood, Fishers, IN (US)

(72) Inventor: Timothy J. Allgood, Fishers, IN (US)

(21) Appl. No.: 15/664,819

(22) Filed: Jul. 31, 2017

(51) Int. Cl. B67D 1/00; B67D 1/08

(52) U.S. Cl. CPC B67D 1/0079; B67D 1/0842; B67D 1/0021

(57) ABSTRACT

A beer tap improvement system for adding an additive to a beer made with a three-way connection component to connect to an outlet nozzle and the three-way connection component configured as (1) a three-way tee with threaded apertures; (2) a removable threaded connection from the three-way tee to an to existing common tap outlet nozzle; (3) a removable threaded connection and aperture from the three-way tee to an outlet nozzle for a mixture of additive and beer; (4) a removable threaded connection from the three-way tee to an additive container and an additive nozzle; (b) the outlet nozzle for a mixture of additive and beer; and (c) the additive container and the additive nozzle where a color or flavor additive can be manually combined with the beer by an operator squeezing the additive container that results in a mixture of the additive and a single beer.

### CROSS-REFERENCE TO RELATED APPLICATIONS

None.

### FIELD OF INVENTION

The embodiments herein generally relate to a beer tap improvement system for colored beer and other additives. Particularly, it is a system that can operate with an existing beer tap and system and provide a manner to add color, flavor or other additives one glass at a time. The present disclosure eliminates the need for buying a whole keg that is colored or from needing to use a complex and expensive system to color or add flavor to beer, wine and other spirits. The present disclosure relates to beverage dispensers, and in particular to alcoholic beverage dispensing equipment that provide for the introduction of additive fluids into alcoholic beverages for coloring and flavoring the original beverage. This disclosure relates generally to a beverage dispenser, and more particularly, to systems and methods for providing both flavor doses and color additives to beverages.

### FEDERALLY SPONSORED RESEARCH

None.

### SEQUENCE LISTING OR PROGRAM

None.

### BACKGROUND

### Description of the Related Art

The consumption of beer and alcoholic spirits is increasing in popularity. Spirits normally have an alcohol content or concentration greater, and often considerably greater, than that of beer. A traditional method of dispensing draft beer is from one or more dedicated beer valves or faucets, each structured to dispense only a single brand of beer. It is known to include an additive in beer, such as green coloring for beer to be served on St. Patrick's Day. An additive can be included in the beer that is supplied to a drink retailer, but that approach increases the number of kegs of beer the retailer must keep on hand. That approach also increases the number of beer faucets required to dispense beer, since a separate faucet must be provided for each type of beer, such as faucets for both colored and uncolored beer. Also, with increasing popularity of spirits consumption, the space required to stock different brands of spirits is demanding on the retailer. Both suppliers of brands and consumers desire new and creative ways to consume beer, wine and spirits. For example, a traditional method of dispensing chilled shots uses a machine that dispenses one brand per faucet. A new, simple and creative way to provide beer and chilled shots would be to include additives at the point of consumption such as color and flavors in brands supplied to a drink retailer. That approach, however, would lower the number of beers with additives and bottles of spirits that the bar and restaurant must keep on hand and therefore decrease the number of dispensing faucets required to dispense various colors and flavors. The new system would have the ability to change the color or flavor with a simple change of an additive container—colors and flavors.

### Problem Solved

Accordingly, it would be desirable to have a system for optionally and selectively introducing one or more additives into a basic draft beer brand or spirit brand dispensed from a single beer faucet.

### PRIOR ART

In prior art, a few disclosures have been made, many including more complex devices and systems to introduce flavors to beer and spirits. None is as simple and direct to give one colored or flavored beverage at a time like the improved system by Allgood.

TABLE A

| Item | Patent/Add | | | Year |
|---|---|---|---|---|
| No. | Number | Name | Inventor | Issued |
| 1 | 7,878,370 | Alcoholic Beverage | Sevcik et | 2011 |
| | | Dispenser With | al. | |
| | | Additive Injection | | |
| 2 | US | Production Of Consumable | Sher | 2005 |
| | 2005/0158798 | Alcohols And | | |
| | | Components Thereof | | |
| 3 | wikihow.com | How to make Green Beer | None | None |

### SUMMARY

In view of the foregoing, an embodiment herein provides a beer tap improvement system for adding an additive to a beer wherein the beer tap improvement system comprises: (a) a three-way connection component to removably connect the component with an additive container to outlet nozzle, wherein the three-way connector is made of durable material and comprises: (1) a three-way tee with threaded apertures; (2) a removable threaded connection from the three-way tee to an to existing common tap outlet nozzle; (3) a removable threaded connection and aperture from the three-way tee to an outlet nozzle for a mixture of additive and beer; (4) a removable threaded connection from the three-way tee to an additive container and an additive nozzle; (b) the outlet nozzle for a mixture of additive and beer; and (c) the additive container and the additive nozzle are further comprised of a waterproof and pliable material wherein the additive can be manually combined with the beer by an operator squeezing the additive container which releases the additive and then by the operator pulling a beer tap handle which allows the beer to mix with the additive in the three-way connection component and results in a mixture of the additive and a single beer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein without departing from the spirit thereof, and the embodiments herein include all such modifications.

### ADVANTAGES

There are several advantages of the beer tap improvement system for colored beer and other additives. There are currently no known beer tap devices or systems that are effective at providing the advantages and objects of this invention. The overall uniqueness of the system is the additive container and the three-way connector device. Other products either thread onto a beer tap or use complex, multi additive systems with electrical and pneumatic controls. The beer tap improvement for colored beer and other additives uses a simple container that is totally controlled by the operator or bar tender one glass at a time. Likewise the changeover of the color or flavor container is much faster to install than any competitors product. In a table fashion the beer tap improvement system for colored beer and other offers

TABLE B

| Item | Advantage |
|---|---|
| 1 | Eliminates the need for pre-colored or pre-flavored beer |
| 2 | Saves change over time to pre-colored or pre-flavored beer kegs |
| 3 | Saves left-over pre-colored or pre-flavored beer in full kegs after |
| | special event |
| 4 | Can be installed without tools |
| 5 | Is able to be handle a full keg |
| 6 | Is ergonomic and saves extra bending and twisting by an installer |

### BRIEF DESCRIPTION OF THE DRAWINGS

The embodiments herein will be better understood from the following detailed description with reference to the drawings, in which:

FIGS. 1A through 1D are diagrammatic representations of a beer tap improvement system for colored beer and other additives to beverages servable by a tap system.

FIGS. 2A through 2D are sketches of the component and their features that are used for the beer tap improvement system for colored beer and other additives to beverages.

FIGS. 3A and 3B show sketches of typical beer tap systems which can use the disclosed improvement system.

FIGS. 4A through 4E are sketches showing how the beer tap improvement system is installed with typical beer tap systems and then how it operates.

FIGS. 5A through 5C are prior art attempts for comparison with the new device.

### DESCRIPTION OF THE DRAWINGS—REFERENCE NUMERALS

The following numbers refer to the drawings

TABLE C

| Ref # | Description |
|---|---|
| 30 | beer tap improvement 30 system for colored beer and other |
| | additives |
| 31 | three-way connection component 31 to removably connect |
| | container with colored or flavored additive container 33 to an |
| | outlet nozzle 44, the device is made of durable material such as |
| | stainless steel, metal (steel, aluminum etc.) with powder coat or |
| | other sterilizable surface coating, sterilizable plastic, or sterilizable |
| | composite material |
| 32 | colored or flavored additive 32 |
| 33 | colored or flavored additive container 33 that is replaceable or |
| | refillable with additive 32 and is comprised of a waterproof and |
| | pliable material such as composite materials, plastics, nylon, |
| | reinforced nylon, High-density polyethylene(HDPE), polyethylene |
| | high-density(PEHD), polyethylene terephthalate (PET, PETE), |
| | Polyethylene Low-density (LDPE), Polypropylene (PP), and |
| | Polymethyl Methacrylate (PMMA or Acrylic). |
| 34 | multi-piece additive container 34 with replaceable nozzle and is |
| | comprised of a waterproof and pliable material such as composite |
| | materials, plastics, nylon, reinforced nylon, High-density |
| | polyethylene(HDPE), polyethylene high-density(PEHD), |
| | polyethylene terephthalate (PET, PETE), Polyethylene Low- |
| | density (LDPE), Polypropylene (PP), and Polymethyl |
| | Methacrylate (PMMA or Acrylic). |
| 35 | relative larger additive container (as compared with the standard |
| | container 33) the larger one keg size additive container 35 and is |
| | comprised of a waterproof and pliable material such as composite |
| | materials, plastics, nylon, reinforced nylon, High-density |
| | polyethylene(HDPE), polyethylene high-density(PEHD), |
| | polyethylene terephthalate (PET, PETE), Polyethylene Low- |
| | density (LDPE), Polypropylene (PP), and Polymethyl |
| | Methacrylate (PMMA or Acrylic). |
| 36 | lid 36 for larger additive container 35 |
| 37 | replaceable nozzle 37 comprised of a waterproof and pliable |
| | material |
| 38 | fixed nozzle 38 comprised of a waterproof and pliable material |
| 39 | support plane, table or surface 39 |
| 42 | beer and CO2 inlet line 42 |
| 43 | open and closed valve 43 controlled by an operator movable |
| | handle 46 to dispense beer 50 |
| 44 | outlet nozzle 44 |
| 45 | outlet nozzle 45 for beer on the three-way connection component |
| | 31 |
| 46 | an operator movable handle 46 |
| 50 | beer 50 |
| 51 | beer source or keg 51 |
| 52 | beer inlet 52 |
| 54 | common beer supply system 54 |
| 54A | common beer tap system 54A where beer 50 is dispensed to |
| | consumers |
| 55 | CO2 source 55 |
| 56 | CO2 regulator 56 |
| 57 | beer glass, mug 57 |
| 59 | mixed beer 59 that is a beer 50 with additive 32 |
| 60 | connecting three-way tee 60 with threaded apertures for the three- |
| | way connection component 31 to removably connect container |
| | with colored or flavored additive container 33 to outlet nozzle 44 |
| 61 | removable threaded connection 61 from three-way tee 60 to |
| | mixture of additive and beer outlet nozzle 45 |
| 62 | removable threaded connection 62 from three-way tee 60 to |
| | additive container 33, 34, 35 and the additive nozzle 37, 38 |
| 63 | removable threaded connection 63 from three-way tee 60 to |
| | existing common tap outlet nozzle 44 |
| 64 | removable threaded connection 64 from the three-way tee 60 to |
| | the connection 63, the connection 64 as connector nuts and tubes |
| | or an integral single piece |
| 65 | integrally manufactured connection component 65 functionally |
| | like 31, integral device cast or molded from durable material such |
| | as stainless steel, metal (steel, aluminum etc.) with powder coat or |
| | other sterilizable surface coating, sterilizable plastic, or sterilizable |
| | composite material |
| 70 | one squeeze 70 to the container 33 |
| 77 | engage or operate 77 the operator movable handle 46 |
| 90 | prior art 90 US Patent No. 7,878,370 |
| 91 | prior art 91 common food color dropper - one glass at a time |
| 92 | tap 92 with automatic or multi-flavor additives for system 90 |
| 100 | operator 100 |

### DETAILED DESCRIPTION OF THE PREFERRED EMBODIMENTS

The present development is a Beer tap improvement system for colored beer and other additives. The embodiments herein generally relate to a beer tap improvement system for colored beer and other additives. Particularly, it is a system that can operate with an existing beer tap and system and provide a manner to add color, flavor or other additives one glass at a time. The present disclosure eliminates the need for buying a whole keg that is colored or from needing to use a complex and expensive system to color or add flavor to beer, wine and other spirits. The present disclosure relates to beverage dispensers, and in particular to alcoholic beverage dispensing equipment that provide for the introduction of additive fluids into alcoholic beverages for coloring and flavoring the original beverage. This disclosure relates generally to a beverage dispenser, and more particularly, to systems and methods for providing both flavor doses and color additives to beverages.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The advantages for the beer tap improvement system for colored beer and other additives 30 are listed above in the introduction. Succinctly the benefits are that the device:

A. Eliminates the need for pre-colored or pre-flavored beer

B. Saves change over time to pre-colored or pre-flavored beer kegs

C. Saves left-over pre-colored or pre-flavored beer in full kegs after special event

D. Can be installed without tools

E. Is able to be handle a full keg

F. Is ergonomic and saves extra bending and twisting by an installer

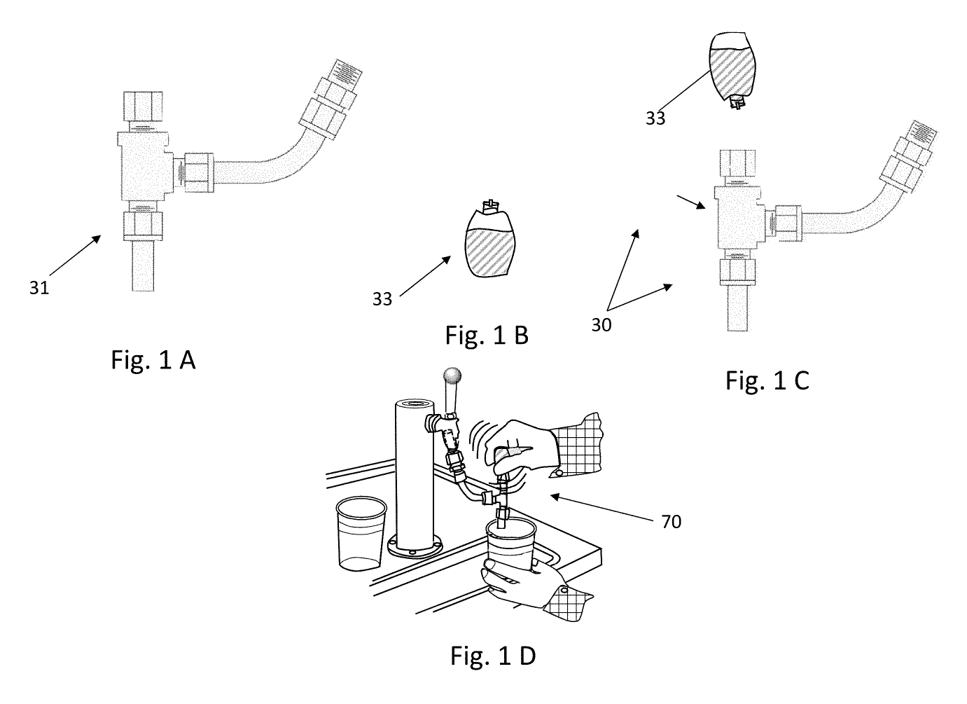

Accordingly, it would be desirable to have a system for optionally and selectively introducing one or more additives into a basic draft beer brand or spirit brand dispensed from a single beer faucet. Refer now to the drawings, and more particularly to FIGS. 1 through 5, where similar reference characters denote corresponding features consistently throughout the figures and there are shown preferred embodiments.

FIGS. 1A through 1D are diagrammatic representations of a beer tap improvement system 30 for colored beer and other additives to beverages servable by a tap system 54. Provided in these sketches are: a beer tap improvement 30 system for colored beer and other additives; a three-way connection component 31 to removably connect container with colored or flavored additive a container 33 to an outlet nozzle 44; an additive container 33; and one squeeze 70 to the additive container 33.

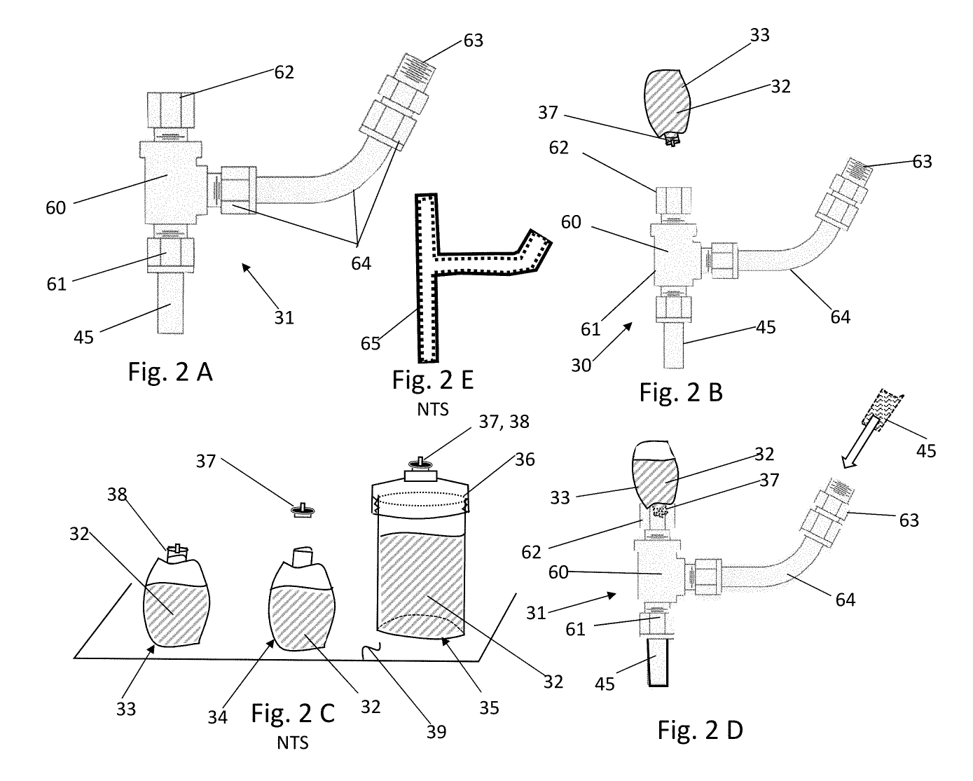

FIGS. 2A through 2D are sketches of the component and their features that are used for the beer tap improvement system 30 for colored beer and other additives to beverages. Here are provided sketches of: three-way connection component 31 to removably connect the container with colored or flavored additive container 33 to an outlet nozzle 44; a colored or flavored additive 32; a colored or flavored additive container 33 that is replaceable or refillable with additive 32 and is comprised of a waterproof and pliable material such as composite materials, plastics, nylon, reinforced nylon, High-density polyethylene(HDPE), polyethylene high-density(PEHD), polyethylene terephthalate (PET, PETE), Polyethylene Low-density (LDPE), Polypropylene (PP), and Polymethyl Methacrylate (PMMA or Acrylic); a multi-piece additive container 34 with replaceable nozzle; a relative larger additive container (as compared with the standard container 33) the larger a keg size additive container 35; a lid 36 for larger additive container 35; a replaceable nozzle 37 comprised of a waterproof and pliable material such as composite materials, plastics, nylon, reinforced nylon, High-density polyethylene(HDPE), polyethylene high-density(PEHD), polyethylene terephthalate (PET, PETE), Polyethylene Low-density (LDPE), Polypropylene (PP), and Polymethyl Methacrylate (PMMA or Acrylic); a fixed nozzle 38 comprised of a waterproof and pliable material such as composite materials, plastics, nylon, reinforced nylon, High-density polyethylene(HDPE), polyethylene high-density(PEHD), polyethylene terephthalate (PET, PETE), Polyethylene Low-density (LDPE), Polypropylene (PP), and Polymethyl Methacrylate (PMMA or Acrylic); a support plane, table or surface 39; an outlet nozzle 45 for beer on the three-way connection component 31; a connecting three-way tee 60 with threaded apertures for the three-way connection component 31 to removably connect container with colored or flavored additive container 33 to outlet nozzle 44; a removable threaded connection 61 from three-way tee 60 to mixture of additive and beer outlet nozzle 45; a removable threaded connection 62 from three-way tee 60 to additive container 33, 34, 35 and the additive nozzle 37, 38; a removable threaded connection 63 from the three-way tee 60 to an existing common tap outlet nozzle 44; a removable threaded connection 64 from three-way tee 60 to the connection 63, the connection 64 as connector nuts and tubes or an integral single piece from three-way tee 60 to the connection 63, the connection 64 as connector nuts and tubes or an integral single piece; and a single, integrally manufactured three-way connection component 65 functionally like the three-way connection component 31, integral device cast or molded from durable material such as stainless steel, metal (steel, aluminum etc.) with powder coat or other sterilizable surface coating, sterilizable plastic, or sterilizable composite material. Note that sterilizable is used and defined to mean a material that can sustain extreme heat so that bacteria and virus agents are destroyed. The proper time and temperature for Dry-Heat sterilization is 160 Degrees C. (320 Degrees F.) for 2 hours or 170 Degrees C. (340 Degrees F.) for 1 hour. Instruments should be dry before sterilization since water will interfere with the process. Dry-heat destroys microorganisms by causing coagulation of proteins. A more commonly used method when extended heat is not a concern is to use an autoclave or pressure cooker. When sterilizing in this way, samples are placed into a steam chamber on a shelf or raised floor, and the chamber is closed and heated so that steam forces air out of the vents or exhausts. Pressure is then applied so that the interior temperature reaches 121 Degrees C. (250 Degrees F.), and this temperature is maintained for between 15 and 30 minutes. This elevated temperature and pressure is sufficient to sterilize samples of any commonly encountered microbes or spores. The additive containers 33, 34, 35 may be made by Injection molding (The resin pellets are heated and mechanically mixed in a chamber and then forced under high pressure into a cooled mold. This process is used for containers); by Blow molding (This technique is used in conjunction with extrusion or injection molding. The resin pellets are heated and compressed into a liquid tube, like toothpaste. The resin goes into the chilled mold, and compressed air gets blown into the resin tube. The air expands the resin against the walls of the mold. This process is used to make plastic bottles.); and by Rotational molding (The resin pellets are heated and cooled in a mold that can be rotated in three dimensions. The rotation evenly distributes the plastic along the walls of the mold. This technique is used to make hollow plastic items).

The additives 32 can be a coloring agent or a flavoring agent. There are a plethora of both and more coming every year. Therefore as examples and not limitations to the additives that can be used with the system 30: A. Typical flavoring agents can be from a group of chocolate, coconut, hazelnut, ginger, oak essence, peanut butter, caramel, apple, pineapple, strawberry, blueberry, sweet tea, orange and apricot. B. Typical coloring agents can be from a group of green, blue, red, yellow, orange and violet. One skilled in additives can continue to increase these lists.

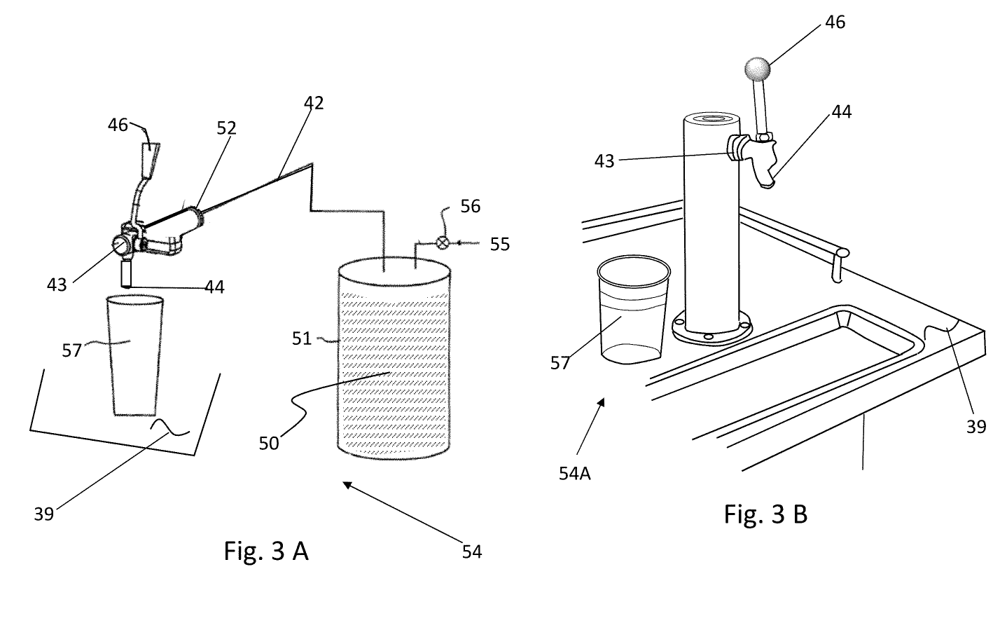

FIGS. 3A and 3B show sketches of typical beer tap systems which can use the disclosed improvement system. Here are shown: a support plane, table or surface 39; an open and closed valve 43 controlled by an operator movable handle 46 to dispense beer 50; an outlet nozzle 44; an operator movable handle 46; a beer 50; a beer source or keg 51; a beer inlet 52; a common beer supply system 54; a common beer tap system 54A where beer 50 is dispensed to consumers; a CO2 source 55; a CO2 regulator 56; and a beer glass, mug 57.

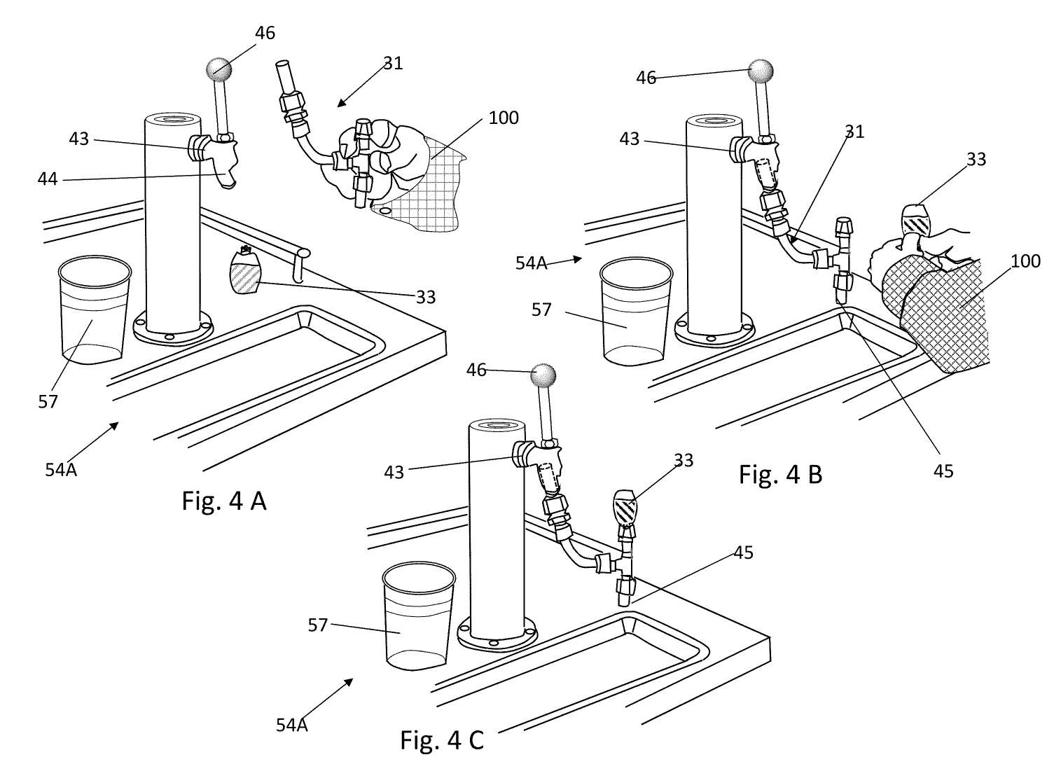

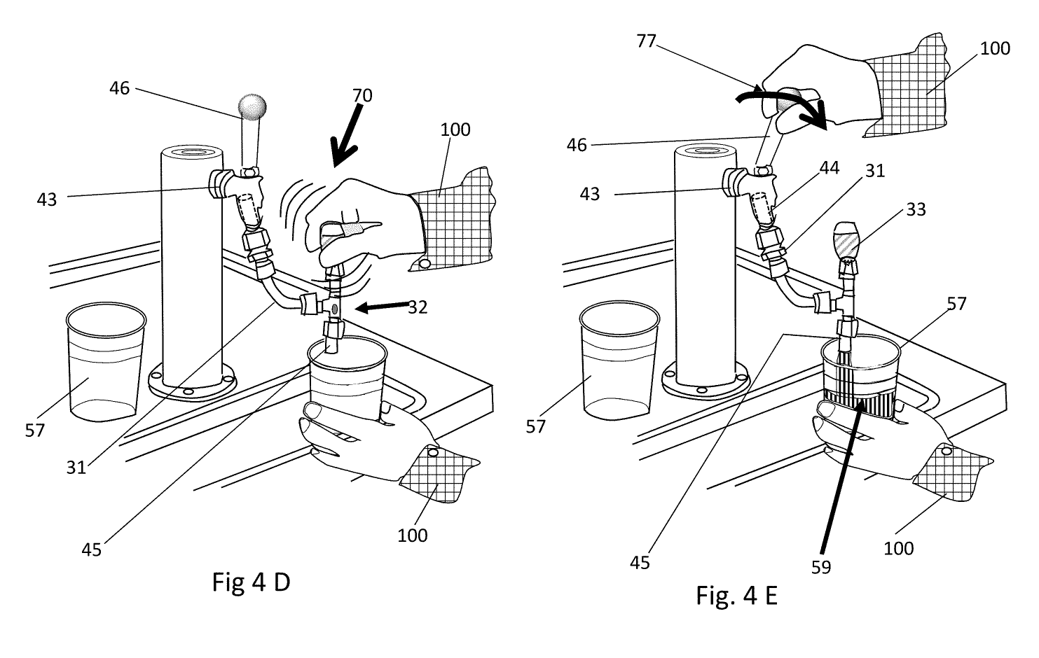

FIGS. 4A through 4E are sketches showing how the beer tap improvement system is installed with typical beer tap systems and then how it operates. These sketches are discussed in the operations section.

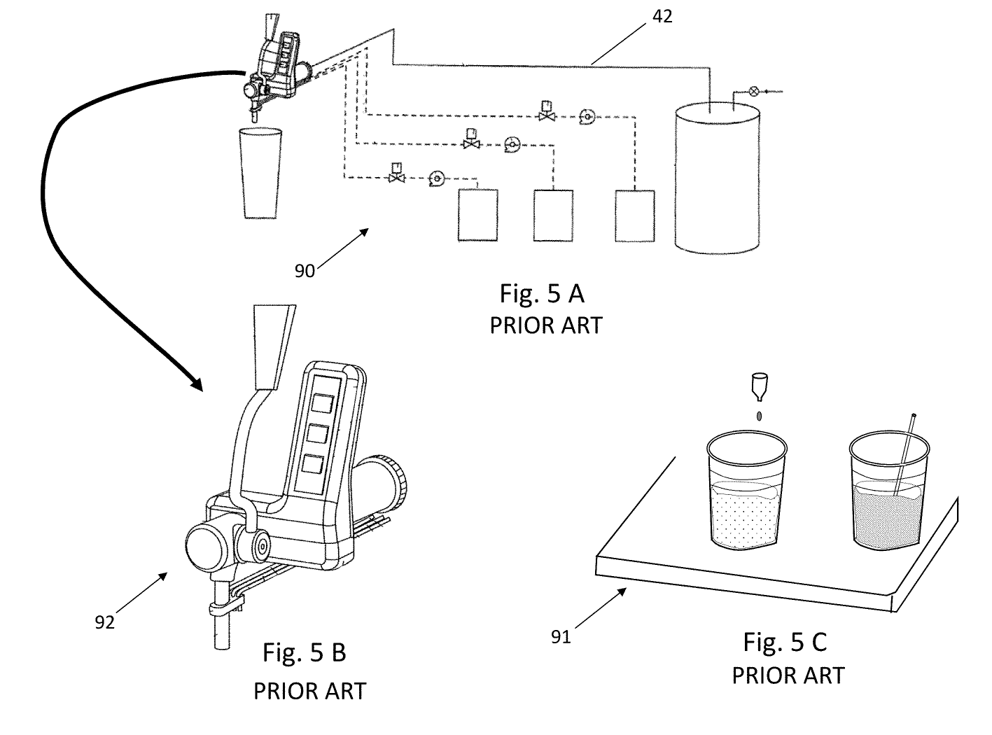

FIGS. 5A through 5C are prior art attempts for comparison with the new device. Shown in these sketches are a very complicated and complex a prior art 90 U.S. Pat. No. 7,878,370. Also shown is the tap 92 with automatic or multi-flavor additives for system 90. This is a complex, automated system with several additive sources shown for flavoring beverages. The complexity would drive a much higher cost compared to the beer tap improvement system 30 for colored beer and other additives. Next is seen a simple, one at a time manual method—a prior art 91—which consists of a common food color dropper—one glass at a time. This manner is slow and tedious as compared with the new system 30.

The details mentioned here are exemplary and not limiting. Other specific components and manners specific to describing a beer tap improvement system for colored beer and other additives 30 may be added as a person having ordinary skill in the field of beer dispensing systems, devices and their uses.

### Operation of the Preferred Embodiment

The beer tap improvement system 30 for colored beer and other additives has been described in the above embodiment. The manner of how the system operates is described below. One notes well that the description above and the operation described here must be taken together to fully illustrate the concept of the improvement system 30. The preferred embodiment of the beer tap improvement system for colored beer and other additives is comprised of: (a) a three-way connection component to removably connect the component with an additive container to outlet nozzle, wherein the three-way connector is made of durable material and comprises: (1) a three-way tee with threaded apertures; (2) a removable threaded connection from the three-way tee to an to existing common tap outlet nozzle; (3) a removable threaded connection and aperture from the three-way tee to an outlet nozzle for a mixture of additive and beer; (4) a removable threaded connection from the three-way tee to an additive container and an additive nozzle; (b) the outlet nozzle for a mixture of additive and beer; and (c) the additive container and the additive nozzle further comprised of a waterproof and pliable material wherein additive can be manually combined with the beer by an operator squeezing the additive container which releases the additive and then by the operator pulling a beer tap handle which allows the beer to mix with the additive in the three-way connection component and results in a mixture of the additive and a single beer.

FIGS. 4A through 4E are sketches showing how the beer tap improvement system 30 is installed with typical beer tap systems 54, 54A and then how improvement system operates. Generally, a typical beer tap systems 54A has a valve 43 that is controlled by a pull handle 46. This handle and valve open the beer and CO2 inlet line 42 and the operator can fill a consumer's mug or glass 57 with beer 50. Traditionally with prior art, if a person wants green beer, it must come from a full keg that has been colored green or from an individual food coloring dropped in a glass and stirred—a slow and cumbersome process. With the new beer tap improvement system 30 for colored beer and other additives, a quicker and simpler system is available. Here in the FIGS. 4A through 4E the system operation is shown. These show the various components and features as follows: a three-way connection component 31 to removably connect the additive container 33 with a colored or flavored additive to an outlet nozzle 44, the connection component 31 is made of durable material such as stainless steel, metal (steel, aluminum etc.) with powder coat or other sterilizable surface coating, sterilizable plastic, or sterilizable composite material; a colored or flavored additive 32; a colored or flavored additive container 33 that is replaceable or refillable with additive 32 and is comprised of a waterproof and pliable material such as composite materials, plastics, nylon, reinforced nylon, High-density polyethylene(HDPE), polyethylene high-density(PEHD), polyethylene terephthalate (PET, PETE), Polyethylene Low-density (LDPE), Polypropylene (PP), and Polymethyl Methacrylate (PMMA or Acrylic); an open and closed valve 43 controlled by an operator movable handle 46 to dispense beer 50; an outlet nozzle 44; an outlet nozzle 45 for beer on the three-way connection component 31; an operator movable handle 46; a common beer tap system 54A where beer 50 is dispensed to consumers; a beer glass, mug 57; a mixed beer 59 that is a beer 50 with additive 32; a squeeze once 70 the container 32; engage or pull or operate 77 the operator movable handle 46; and an operator 100. FIG. 4A shows: the typical beer tap system 54A and the outlet nozzle 44. The three-way connection component 31 to removably connect the additive container 33 with colored or flavored additive to an outlet nozzle 44 is held by the operator 100 and the container 33 with the additive is nearby. FIG. 4B next demonstrates where the operator 100 has attached the three-way connection component 31 to an outlet nozzle 44. The component 31 slides over the nozzle 44 and has the provision to thread onto some common tap systems 54A. The operator 100 then picks up the additive container 33 and inverts it for installation. FIG. 4C shows the additive container 33 in place and removably connected to the threads of the three-way connection component 31 and to the outlet nozzle 44. FIG. 4D demonstrates the operator 100 squeezing 70 the additive container 33 and a drop of additive 32 engaging and mixing with the beer 50 in the three-way tee 60. FIG. 4A shows the mixture of additive and beer 59 then continues to the glass or mug 57 as the operator 100 releases more beer 50 when he engages or pulls or operates 77 the operator movable handle 46. This process is repeated until the additive 32 is used, then the container 33 is replaced and the system continues to give the beer 50 mixed with the additive 32.

With this description it is to be understood that the beer tap improvement system 30 for colored beer and other additives is not to be limited to only the disclosed embodiment of product. The features of the improvement system 30 are intended to cover various modifications and equivalent arrangements included within the spirit and scope of the description.

Unless it is defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y) Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A beer tap improvement system for adding an additive to a beer wherein the beer tap improvement system is comprised of: (a) a three-way connection component to removably connect the component with an additive container to outlet nozzle, wherein the three-way connector is made of durable material and comprises: (1) a three-way tee with threaded apertures; (2) a removable threaded connection from the three-way tee to an to existing common tap outlet nozzle; (3) a removable threaded connection and aperture from the three-way tee to an outlet nozzle for a mixture of additive and beer; (4) a removable threaded connection from the three-way tee to an additive container and an additive nozzle; (b) the outlet nozzle for a mixture of additive and beer; and (c) the additive container and the additive nozzle further comprised of a waterproof and pliable material wherein additive can be manually combined with the beer by an operator squeezing the additive container which releases the additive and then by the operator pulling a beer tap handle which allows the beer to mix with the additive in the three-way connection component and results in a mixture of the additive and a single beer.

2. The beer tap improvement system of claim 1, wherein the durable material of the three-way connection component is a material selected from a group of stainless steel, metal with powder coat, metal with a sterilizable surface coating, steel with powder coat, steel with a sterilizable surface coating, aluminum with powder coat, aluminum with a sterilizable surface coating, sterilizable plastic, and sterilizable composite material.

3. The beer tap improvement system of claim 1, wherein the additive container and an additive nozzle is a configuration selected from a group of fixed nozzle; separate nozzle; lid and fixed nozzle and lid and separate nozzle.

4. The beer tap improvement system of claim 1, wherein the waterproof and pliable material for the additive container and the additive nozzle is a material selected from a group of composite materials, plastics, nylon, reinforced nylon, High-density polyethylene, polyethylene high-density, polyethylene terephthalate, Polyethylene Low-density, Polypropylene, Polymethyl Methacrylate and Acrylic.

5. The beer tap improvement system of claim 1, wherein the additive is a material selected from a group of coloring additives and flavoring additives.

6. The beer tap improvement system of claim 1, wherein the coloring additive is a material selected from a group of green, blue, red, yellow, orange and violet.

7. The beer tap improvement system of claim 1, wherein the flavoring additive is a material selected from a group of chocolate, coconut, hazelnut, ginger, oak essence, peanut butter, caramel, apple, pineapple, strawberry, blueberry, sweet tea, orange and apricot.

8. A beer tap improvement system for adding an additive to a beer wherein the beer tap improvement system comprises:
(a) a single integrally manufactured three-way connection component made from durable material and made to removably connect the component with an outlet nozzle for a mixture of additive and beer, an existing common tap outlet nozzle and an additive container and an additive nozzle;
(b) the outlet nozzle for a mixture of additive and beer; and
(c) the additive container and the additive nozzle further comprised of a waterproof and pliable material
wherein additive can be manually combined with the beer by an operator squeezing the additive container which releases the additive and then by the operator pulling a beer tap handle which allows the beer to mix with the additive in the three-way connection component and results in a mixture of the additive and a single beer.

9. The beer tap improvement system of claim 1, wherein the durable material of the single integrally manufactured three-way connection component is a material selected from a group of stainless steel, metal with powder coat, metal with a sterilizable surface coating, steel with powder coat, steel with a sterilizable surface coating, aluminum with powder coat, aluminum with a sterilizable surface coating, sterilizable plastic, and sterilizable composite material.

10. A beer tap improvement system for adding a color additive to a beer wherein the beer tap improvement system comprises:
(a) a three-way connection component to removably connect the component with an additive container to outlet nozzle, wherein the three-way connector is made of stainless steel and comprises:
a three-way tee with threaded apertures;
a removable threaded connection from the three-way tee to an to existing common tap outlet nozzle;
a removable threaded connection and aperture from the three-way tee to an outlet nozzle for a mixture of additive and beer;
a removable threaded connection from the three-way tee to an additive container and an additive nozzle fixed or a separate component or a lid and fixed or a lid and separate;
(b) the outlet nozzle for a mixture of additive and beer; and
(c) the additive container and the additive nozzle further comprised of a waterproof and pliable material
wherein the color additive can be manually combined with the beer by an operator squeezing the color additive container which releases the additive and then by the operator pulling a beer tap handle which allows the beer to mix with the color additive in the three-way connection component and results in a mixture of the color additive and a single beer.
